(19) United States
(12) Patent Application Publication
(10) Pub. No.: US 2007/0009690 A1
(43) Pub. Date: Jan. 11, 2007

(54) Tight packing , use of this packing for packaging a product and packaging obtained thereby

(75) Inventors: Claude Baudrenghien, Gosselies (BE); Josee Cambier, Gosselies (BE)

Correspondence Address: CHAPMAN AND CUTLER, 111 WEST MONROE STREET, CHICAGO, IL, 60603, US

(73) Assignee: S. P. R. L. Josee Cambier, Gosselies (BE)

(21) Appl. No.: 10/565,690

(22) PCT Filed: Aug. 5, 2004
(86) PCT No.: PCT/BE04/00114

§ 371 Date: Jan. 24, 2006

(30) Foreign Application Priority Data
Aug. 6, 2003 (BE) 2003/0435

(51) Int. Cl. B32B 27/32

(52) U.S. Cl. 428/35.2

(57) ABSTRACT

A sealed package comprising a flexible airtight envelope (30), pierced by a slot (5), and a strip (10) including two parallel self adhesive faces, of which one (16) is covered with a detachable protective strip (17) and of which the other includes a first zone (12) that is fixed to a wall (2) of the envelope, along a lip (9) of the said slot and a second zone (14) that is covered with a detachable protective strip (15) and which extends in front of the slot and beyond a second lip (23) of the last.

### SUBJECT OF INVENTION

The invention relates to sealed packages.

It more particularly concerns sealed packages, specially designed to achieve airtight packaging, capable of resisting high pressures and large temperature variations.

### TECHNOLOGICAL BACKGROUND

To allow the transport in safe conditions of small quantities of dangerous materials, particularly by air, packages subject to very strict requirements are used.

One of these applications is the transport of vials containing “diagnostic specimens”, that is to say samples taken, for example, from man or animal.

Other applications consist of the transport of small quantities of materials of determined danger level, for example chemical products that can be aggressive.

In the case of “diagnostic specimens”, the “International Air Transport Association” (abbreviated as: “I.A.T.A.”), has set the rule “Packaging Instruction 650-diagnostic specimens”. This rule requires that the samples shall be contained in sealed “primary receptacles” and that the latter shall be contained in leakproof “secondary packaging”.

The invention relates in particular to this leakproof “secondary packaging”.

The rule cited above, requires that the “secondary packaging” resists without leakage a pressure difference between the inside and outside, in fact an internal overpressure of 0.95 bar and this over a temperature range from ˜40° C. to +55° C.

In addition a “secondary packaging” must contain an absorbing material (except when the “specimen” is solid).

The aim is to avoid any contamination by the products that escape in exceptional circumstances such as the depressurization of an aircraft hold or an accident.

Very generally, the “secondary packaging” is currently made up of two envelopes one inside the other, one of which essentially ensures sealing, the other resistance to internal overpressure.

The closure arrangement comprises a difficulty generally encountered in the design of “secondary packaging.”

In document U.S. Pat. No. 6,012,844, a sealed package is proposed, comprising, in the one part an envelope provided with an opening, and in the other part, a self adhesive film that is closed over the opening and seals onto the wall of the envelope to close the package. A package of this type does not generally allow compliance with the safety conditions stated in the air transport safety rules cited above. In particular, the closure of the envelope by means of a self-adhesive film does not guarantee the resistance of the packaging to the pressures and temperatures imposed by the said rule.

### AIMS OF THE INVENTION

The invention has the aim of providing a new and original package, meeting severe requirements, in a particular, the above named rule “Packaging Instruction 650-Diagnostic Specimens” imposed for air transport.

Another objective of the invention is to provide a package capable of complying with the severe requirements stated above, which is of low cost.

An additional objective of the invention is to provide a package of this type, whose manipulation is easy, particularly its closure.

The invention has the special objective of a package that will comply with the requirements imposed on the “secondary packaging” that has been discussed above and which can then constitute such a “secondary packaging.”

### MAIN ELEMENTS CHARACTERIZING THE INVENTION

The invention concerns a sealed package comprising, on the one hand, a flexible air-tight envelope, of which one wall is pierced by a slot, and on the other hand, a self adhesive film to close the slot in the envelope, the said package being characterized in that the self adhesive film includes two parallel self adhesive faces, of which one is completely covered with a detachable protective strip and of which the other comprises a first zone that is fixed to the above mentioned wall of the envelope, along a lip of the said slot and a second zone that extends in front of the slot and beyond a second lip of the slot, the said second zone of the self adhesive film being covered with a detachable protective strip.

In the installation in accordance with the invention, the envelope must be flexible and it must be in a material that is capable of resisting the conditions for which it is intended. It is generally formed of two or more sheets of plastic material, welded at their periphery. Depending on the use for which it is intended, the envelope can be opaque or translucent. In the case of a package intended for air transport, the envelope must in particular comply with the above named rule “Packaging Instruction 650-diagnostic specimens”. Notwithstanding the preceding conditions, the profile, the dimensions and the material of the envelope are not critical for the definition of the invention. In practice, the envelope is habitually realized in one of more layers of synthetic polymer. Synthetic polymers that are usable within the context of the invention include halogenated vinyl polymers (particularly chlorinated vinyl polymers, notable polyvinyl chloride and polyvinylidene chloride), the polyolefins (particularly the homopolymers and copolymers of ethylene, propylene and butylene) and the polyamides. Oriented polyamides (OPA) are specially recommended in the case of packages intended for air transport. For this application of the package in accordance with the invention, oriented polyamide sheets are advantageously used, laminated with a polyethylene layer, this last being for preference situated inside the envelope.

The slot is intended to give access to the interior of the envelope, to introduce into it a defined product. Its profile and its position on the wall of the envelope are not critical for the definition of the invention. In a preferred form of realization of the package according to the invention, the slot is approximately rectilinear and it is advantageously situated close to the edge of the envelope. In this preferred form of realization of the invention, it is recommended that the said envelope edge should be approximately rectilinear and approximately parallel to the slot.

The self-adhesive strip is normally a flexible film, whose two faces are self-adhesive. One of these two faces is covered with a protective strip. This protective strip has the function of isolating the said face from the external environment and of thus preserving its self-adhesive character. The protective strip is designed to be able to be removed by pulling off, without changing the self-adhesive character of the said face. The other face of the said self-adhesive strip is subdivided into two contiguous zones, respectively designated “first zone” and “second zone” in the continuation of the present memorandum. The said first zone is fixed to the wall of the envelope, along a lip of the said slot. Any appropriate means can be used to join the said first zone to the wall of the envelope. It can for example include a weld, an adhesive bond, stapling or a combination of these means of fixation. The adhesive bond is preferred. The said second zone prolongs the first zone and extends in front of the slot, in front of the second lip of the slot and beyond this latter. It is covered by a protective strip. This has the same function as the protective strip that covers the other face of the self-adhesive strip and which was discussed above.

As explained above, the self-adhesive strip is normally a flexible film, whose two faces are self-adhesive. Any self adhesive film possessing the properties stated above is suitable for use in the context of the invention. Self-adhesive films that are suitable include an olefin polymer, covered with a rubber-based adhesive. The expression “olefin polymer” indifferently designates homopolymers and olefin copolymers. The ethylene homopolymers and copolymers of propylene and butylene are generally well suited.

To use the package according to the invention an object or product to be enclosed in the envelope is introduced into the envelope through the slot. The protective strips are removed from the self adhesive strip, the above mentioned stripped second zone of the self adhesive strip is sealed onto the envelope wall and the envelope is folded back on itself, so as to fold back on itself the other face, stripped bare, of the self adhesive strip.

In a particular form of realization of the package according to the invention, the envelope extends beyond the above-mentioned second lip of the slot, for a distance at least equal to that of the above-mentioned second zone of the self-adhesive strip. In an advantageous variant of this form of realization of the invention, the length of the aforementioned second zone of the self adhesive strip is at least equal (in preference greater than) the length of the above mentioned first zone of the self adhesive strip. All other things on the other hand being equal, this particular form of realization of the package, according to the invention and its advantageous variant eases the closing of the envelope and reinforces the air tightness of the package and its resistance to mechanical loads.

In another form of particular realization of the package according to the invention, the envelope is divided into several distinct pockets communicating with the slot. This particular form of realization of the invention allows the isolation of several distinct products of objects in the package according to the invention.

The package according to the invention allows the realization of airtight conditions, capable of resisting large mechanical forces, especially large pressure and large temperature variations. It particularly allows the realization of airtight conditions that comply with the standards set by the air transport regulations, especially those of the above named rule “Packaging Instruction 650-diagnostic specimens”.

The invention also concerns a process for the airtight packaging of a product, according to which
a package according to the invention is implemented, as defined above;
the product is introduced into the above mentioned envelope of the package, through the slot of this latter;
the protective strip covering the second zone of the said self adhesive strip is removed and the said second zone is sealed on the second lip of the slot and onto the wall of the envelope;
the protective strip is removed from the other face of the self adhesive strip; and
the envelope is folded back on itself along the slot, so that the stripped face of the self-adhesive strip is folded back on itself.

In the procedure according to the invention, the term “product” must be considered in a generally accepted meaning and indifferently designates a solid material object, a powder or a liquid. It can be a bottle, an ampoule or a vial containing a powder or a liquid.

The procedure according to the invention achieves optimum packaging air-tightness. It allows packaging in accordance with the above named rule “Packaging Instruction 650-diagnostic specimens”. In particular it allows packaging whose air-tightness is retained under a relative overpressure at least equal to 0.5 bar, generally at least equal to 0.9 bar, or even equal or greater than 0.95 bar and under a temperature of −40° C. to +55° C.

The invention also concerns an airtight packaging of a product in a package inside which a relative pressure of at least 0.5 bar and a temperature of −40° C. to +55° C. exist, obtained by the procedure according to the invention, defined above.

In airtight sealing in accordance with the invention, the term “product” has the general definition provided above.

### BRIEF DESCRIPTION OF THE FIGURES

Characteristics and details of the invention will appear in the course of the following description of the attached figures, which represent a particular form of realization of the package according to the invention and the application, to this, of a particular form of execution of the procedure according to the invention.

FIG. 1 represents a front view of the package;

FIG. 2 is a cut on the plane II-II of FIG. 1;

FIG. 3 represents the package of FIGS. 1 and 2 schematically in cross section without content;

FIG. 4 is an analogous view to FIG. 2, showing the closed package;

FIG. 5 is an analogous view to FIG. 4, showing the closure zone of the closed package, inflated to the test pressure.

FIG. 6 represents the self-adhesive strip serving to close the package of FIGS. 1 to 5 in cross section.

The figures are not drawn to scale.

Generally, the same reference numbers designate the same elements.

### DETAILED DESCRIPTION OF PARTICULAR METHODS OF IMPLEMENTATION

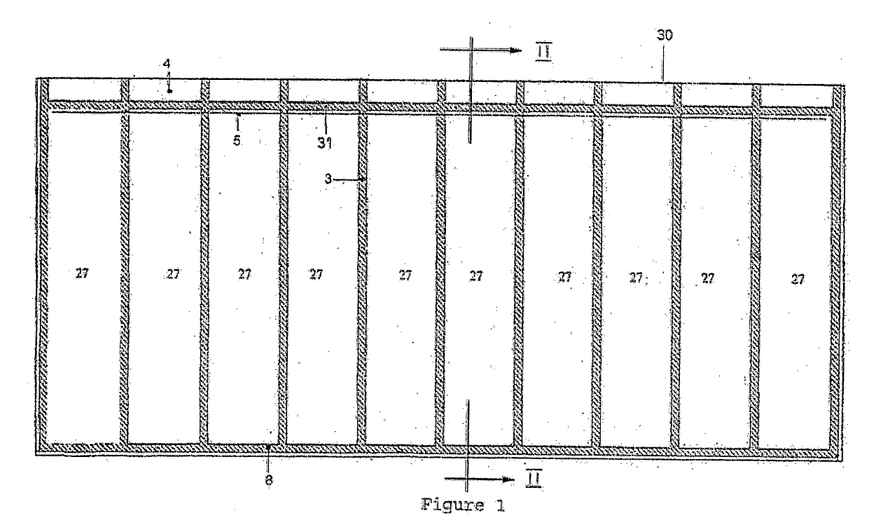

The package represented in the figures includes an envelope designated in its entirety by the notation reference 30 (FIGS. 1, 2 and 3). The envelope 30 is formed from two sheets 2 and 6, welded to each other at their periphery. It is divided into ten juxtaposed pockets 27 (FIG. 1). The scope of the invention is not left by adopting a number of pockets that is greater or less than ten.

The front sheet 2 and the rear sheet 6 are thin films in plastic material. They are hot welded in the zones 3 and 8 surrounding the pockets 27. The welds are represented by hatching.

The sheet 2 is pierced by a rectilinear slot 5, which communicates with the pockets 27. The slot 5 is intended for the insertion, into the pockets 27, of “primary containers” 28 (FIG. 30 or any other object of product and, if necessary, an absorbing material (not represented) if the said primary container or object or product is or includes a liquid. The sheets 2 and 6 are welded to one another by a rectilinear weld bead 31, situated close to the slot 5 and parallel to this last. The sheets 2 and 6 are additionally prolonged beyond the weld bead 31, to form a zone 4 that will be explained below.

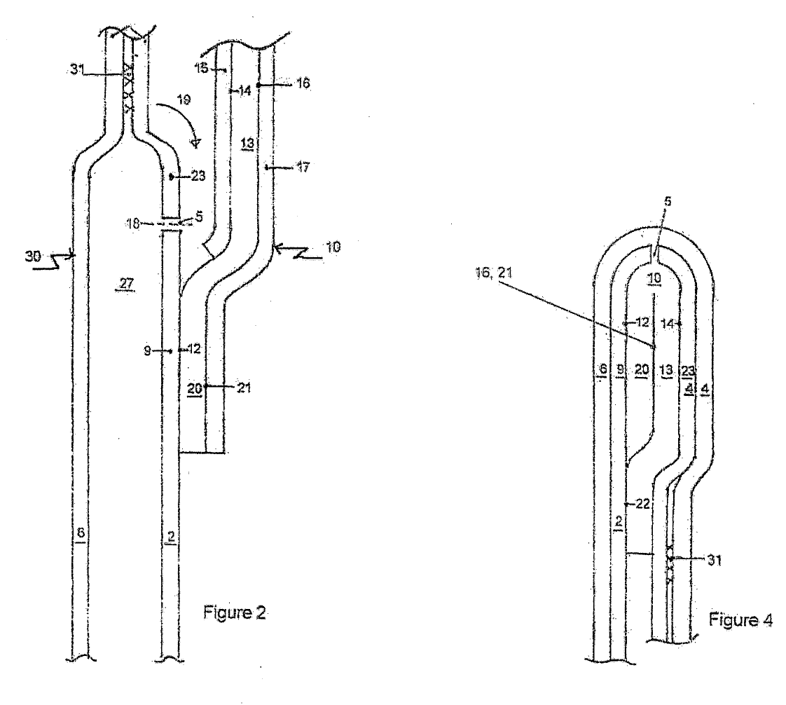

The package includes in addition a self-adhesive strip 10 serving to close it (FIG. 2). The self-adhesive strip 10 is a flexible film (20, 13), whose two faces are covered with a layer of adhesive. The adhesive layer 16 on a face is covered with a protective strip 17. The adhesive layer of the other face of the strip 10 is subdivided into two consecutive zones 12 and 14. Before the manufacture of the package, the zones 12 and 14 are covered with protective strips, respectively 11 and 15 (FIG. 6). During the manufacture of the package, the protective strip 11 is pulled off and the self adhesive zone 12, thus stripped bare, is applied under pressure and sealed on the lip 9 of the slot 5, which is the furthest from the weld bead 31 (FIG. 2). The zone 14 of the self-adhesive strip 10 is normally longer than the zone 12 and it thus extends above the slot 5, the lip 23 of this last, the weld bead 31 and the zone 4 defined above. It is desirable that, in this zone 4, the sheets 2 and 6 are prolonged approximately up to the end of the self-adhesive strip 10.

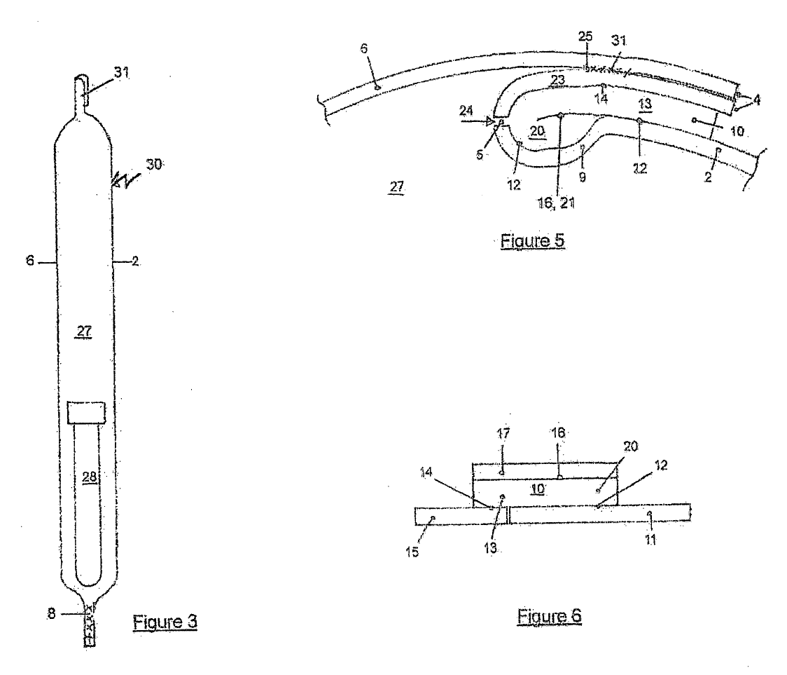

To pack one or more products 28 (FIG. 3) into the package, they are introduced into the pockets 27 of the pocket 30, through the slot 5. The protective strip 15 is then pulled off the adhesive zone 14 and this is applied and bonded to the lips 9 and 23 of the slot 5, as well as to the zone 4 of the sheet 2. The protective strip 17 is then pulled off to strip bare the adhesive layer 16, then the envelope 30 and the self adhesive strip attached to it are folded back, on themselves, in the direction of the arrow 19 (FIG. 2), around the axis 18 of the rectilinear slot 5. The arrangement represented in FIG. 4 is thus obtained.

FIG. 4 represents the zone of closure of the closed package in cross section without the effect of depressurization or of the test pressure. The slot 5 is visible, arranged at the folded angle. The sealing is realized once by hand for all the pockets 27 of the envelope. The end of the package shows in order: the rear sheet 6, the lower lip 9 forming part of the front sheet 2, the adhesive layer 12 on the lower lip 9, the part 20 of the self adhesive strip 10 that adheres to it, the adhesive layers 21 and 16, the part 13 of the self adhesive strip 10, the lip 23 of the slot 5 and the prolongation 4 of the sheets 2 and 6. Given that the zone 14 of the self-adhesive layer is longer than zone 12, the end 22 of the zone 14 overlaps the end 20 of the self-adhesive layer and is applied and bonded to the sheet 2, beyond the said end 20.

The manual application of the flap during bending is sufficient to give the stack of all these layers, adhesion forces that remain effective despite the severe pressure and temperature conditions of the I.A.T.A. rules.

FIG. 5 represents the closure zone of the closed package in cross section, inflated to the test pressure. The test of the preferred form of implementation of the invention described above in the conditions of the I.A.T.A. rule has been undertaken with success by an I.A.T.A approved organization with pressurization of water or liquid in the pockets.

If anyone had been content to implement the closure using a single face self-adhesive applied on the slot, the forces exercised on the adhesive layer at the slot would have progressively pulled off this self-adhesive.

In effect, this arrangement of the self-adhesive leads to the combined application of two types of forces on the adhesive:
a pulling off due to the internal pressure and exercised across the slot, perpendicularly to the surface of the package.

a shearing due to the take up of the force interrupted by the slot.

The self-adhesive strip used in the package according to the invention is commercially available. This type of self-adhesive strip includes an adhesive that remains plastic and whose viscosity reduces with temperature. It cannot in general withstand significant pulling off forces without progressively disbanding.

In the package closure procedure according to the invention, the pulling off force on the adhesive is removed and moved towards the weld bead 31, which is able to withstand it.

FIG. 5 represents the package closure zone subjected to an internal pressure after its closure.

The forces are applied separately in distinct zones:
A pressure on the adhesive in the direction of the arrow 24 and exercised across the lips of the slot 5, as on a stopper. No other force is transmitted to the adhesive by the lips of the slot.
A pressure and a shear 25 on the weld bead 31, which is capable of withstanding them;
A pure shear transmitted from one sheet to the other through the surfaces 14 and 22 of the prolongation 13 of the self adhesive 10.

An adequate dimensioning of the surfaces 14 and 22 allows resistance to the envisaged forces without creep of the adhesive.

In the package represented in the figures, the sheets 2 and 6 are advantageously thin combined sheets of oriented polyamide-polyethylene (OPA/PE). The polyethylene faces are arranged on the inside faces of the pockets 27. The double-sided self-adhesive strip 10 preferred as a function of the I.A.T.A. application requirements and for its cost is “Pressure Sensitive Adhesive” (PSA). It is made up of a polyethylene film (13, 20) coated on each face with an acrylic, or for preference a rubber based adhesive. The research undertaken to offer a package meeting the I.A.T.A. requirements has lead to a preference for the solutions and materials described. For other more severe or even less severe applications or in other conditions, for example the dimensions of the contents, the means in accordance with the invention are usable by selecting more or less high performance materials, at greater or lesser costs.

1. An air-tight package comprising a flexible air-tight envelope, of which one wall (2) is pierced by a slot (5), and a self adhesive strip to close the slot in the envelope, wherein the self adhesive strip (10) comprises two parallel self adhesive faces, wherein a first of said faces (16, 21) is completely covered with a detachable protective strip (17), and wherein a second of said faces comprises a first zone (12) that is fixed to the wall (2) of the envelope, along a lip (9) of said slot (5) and a second zone (14) that extends in front of the slot and beyond a second lip (23) of the slot, said second zone of the self adhesive strip being covered with a detachable protective strip (15).

2. A package according to claim 1, wherein the envelope (30) extends beyond (4) second lip (23) of the slot (5), for a distance at least equal to a length of the second zone (14) of the self adhesive strip (10).

3. A package according to claim 2, wherein the length of the second zone (14) of the self adhesive strip (10) is at least equal to a length of the first zone (12) of the self adhesive strip.

4. A package according to claim 1, wherein the slot (5) is rectilinear.

5. A package according to claim 4, wherein the slot (5) is arranged close to a rectilinear edge (31) of the envelope (30).

6. A package according to claim 1, wherein the envelope (30) is divided into a plurality of distinct pockets (27) communicating with the slot (5).

7. A package according to claim 1, wherein the envelope (30) comprises at least one sheet (2, 6) in oriented polyamide, laminated with a polyethylene layer inside the envelope (30).

8. A package according to a claim 1, wherein the self adhesive strip (10) comprises at least one sheet (13, 20) of synthetic olefin polymer, covered with a rubber based adhesive (12, 14, 16, 21).

9. A method for airtight packing of a product, comprising the steps of:
providing a package according to claim 1;
inserting the product (28) into the envelope (30), through the slot (5);
removing the protective strip (15) covering the second zone (14) of the self adhesive strip (10), and sealing said second zone on the second lip (23) of the slot and onto the wall (4) of the envelope;
removing the protective strip (17) from the first face (16) of the self adhesive strip; and
folding the envelope back on itself along the slot, so that the stripped face of the self-adhesive strip is folded back on itself.

10. A method for airtight packing of a product according to claim 9, wherein a relative pressure of at least 0.95 bar and a temperature of −40° C. to 55° C. exist inside said package after packing.

11. A package according to claim 2, wherein the slot (5) is rectilinear.

12. A package according to claim 3, wherein the slot (5) is rectilinear.

13. A package according to claim 2, wherein the envelope (30) is divided into a plurality of distinct pockets (27) communicating with the slot (5).

14. A package according to claim 3, wherein the envelope (30) is divided into a plurality of distinct pockets (27) communicating with the slot (5).

15. A package according to claim 4, wherein the envelope (30) is divided into a plurality of distinct pockets (27) communicating with the slot (5).

16. A package according to claim 2, wherein the envelope (30) comprises at least one sheet (2, 6) in oriented polyamide, laminated with a polyethylene layer inside the envelope (30).

17. A package according to claim 3, wherein the envelope (30) comprises at least one sheet (2, 6) in oriented polyamide, laminated with a polyethylene layer inside the envelope (30).

18. A package according to claim 4, wherein the envelope (30) comprises at least one sheet (2, 6) in oriented polyamide, laminated with a polyethylene layer inside the envelope (30).

19. A package according to claim 2, wherein the self adhesive strip (10) comprises at least one sheet (13, 20) of synthetic olefin polymer, covered with a rubber based adhesive (12, 14, 16, 21).

20. A package according to claim 3, wherein the self adhesive strip (10) comprises at least one sheet (13, 20) of synthetic olefin polymer, covered with a rubber based adhesive (12, 14, 16, 21).
